(19) United States
(12) Patent Application Publication
(10) Pub. No.: US 2011/0083299 A1
(43) Pub. Date: Apr. 14, 2011

(54) FURNITURE HINGE

(75) Inventor: Boris Krüdener, Darmstadt (DE)

(73) Assignee: GRASS GMBH & CO. KG, Reinheim (DE)

(21) Appl. No.: 12/905,479

(22) Filed: Oct. 15, 2010

Related U.S. Application Data
(63) Continuation of application No. PCT/EP2009/002497, filed on Apr. 9, 2009.

(30) Foreign Application Priority Data
Apr. 16, 2008 (AT) A598/2008

(51) Int. Cl. E05D 7/06; E05F 5/02

(52) U.S. Cl. 16/319; 16/382

(57) ABSTRACT

A furniture hinge with a door-leaf attachment part (1) for fastening to a door leaf (36) and a carcass attachment part (2) connected to the hinge so that it can pivot for fastening to a furniture carcass (37). At least one functional unit (3) influences a pivoting movement between the door-leaf attachment part (1) and the carcass attachment part (2). The carcass attachment part (2) has a first component (4) and at least one second component (5), and the first component (4) is supported on the second component (5) at least by at least one adjustment device (6), and a relative position of the first component (4) to the second component (5) can be adjusted with the adjustment device (6). The functional unit (3) has a first functional element (8) and at least one second functional element (9), the first functional element (8) is supported so that it can move relative to the second functional element (9), and the first functional element (8) is fastened to or supported on the adjustment device (6).

### CROSS-REFERENCE TO RELATED APPLICATIONS

This application is a continuation of PCT/EP2009/002497, filed Apr. 4, 2009, which claims the benefit of Austrian Application A598/2008, filed Apr. 16, 2008, both of which are incorporated herein by reference as if fully set forth.

### BACKGROUND

1. Field of the Invention

The present invention relates to a furniture hinge with a door-leaf attachment part for fastening to a door leaf and a carcass attachment part connected to this hinge so that it can pivot for fastening to a furniture carcass, and at least one functional unit, in particular, a damper, for influencing a pivoting movement between the door-leaf attachment part and the carcass attachment part. The carcass attachment part has a first component and at least one second component and the first component is supported on the second component at least by means of at least one adjustment device, in particular, an adjustment screw, and the relative position of the first component to the second component can be adjusted with the adjustment device. The functional unit has a first functional element and at least one second functional element, and the first functional element is supported so that it can move relative to the second functional element.

2. Description of Related Prior Art

Furniture hinges of this type are known in the prior art. The door-leaf attachment part is frequently built from a hinge pot and the carcass attachment part is frequently built from a so-called hinge arm. Other embodiments, however, are also known, e.g., for glass doors in which, instead of the hinge pot, door-leaf attachment parts with flat adhesive faces are used. In order to be able to influence the pivoting movement between the door-leaf attachment part and the carcass attachment part, these hinges today have functional units. These could be constructed, e.g., as dampers for damping the closing and/or opening movement of the door-leaf attachment part. There are also functional units, however, in the form of closing springs or electric motors that are provided for influencing the pivoting movement between the door-leaf attachment part and the carcass attachment part. As an example for different attachments of a functional unit in the form of a damper on the furniture hinge, reference is made to WO 2008/011955 A1. This furniture hinge has a slide that is pressed by the door-leaf attachment part during the closing movement of the furniture hinge and is coupled with a piston rod as a functional element of the damper. The piston rod is pushed into a cylinder that is supported fixed in position as a second function element of the damper on the hinge arm. A reverse arrangement is known from WO 2008/009345. Here, an activation part is connected to one of the articulated levers of the furniture hinge. This guides the movement of the articulated lever in the second embodiment of this publication by an activation part onto the cylinder of the damper, so that this is moved relative to the hinge arm and to the piston rod.

In the two mentioned publications, the damper or the functional unit is arranged in the interior of the carcass attachment part and requires there a large part of the space within the carcass attachment part. In the mentioned publications, therefore, adjustment devices for the height, depth, or contact adjustment of the carcass attachment part were eliminated.

For furniture hinges according to the class in which at least one such adjustment device is not eliminated, the dampers or other functional units are usually fastened to the outside on the door-leaf attachment part or on the carcass attachment part, so that, in the carcass attachment part, there is sufficient space for the adjustment devices. Furniture hinges according to the class are shown, e.g., in WO 2005/088052 A1.

### SUMMARY

The invention is designed to construct the attachment of a functional unit on the remaining components of a furniture hinge according to the class in a way that is as space-efficient and simple as possible.

This is achieved according to the invention in that the first functional element is fastened to or supported on the adjustment device.

One basic idea of the invention is thus to allocate a double function to at least one adjustment device of the furniture hinge. Thus, in the furniture hinge according to the invention, the adjustment device is used on one hand for its known function, e.g., for height, depth, and/or contact adjustment. In addition, according to the invention, however, the adjustment device is also used as a fastening device on which the first functional element of the functional unit is fastened or at least supported. Here, it preferably involves the most direct possible connection between the functional element and adjustment device. Thus, it is possible to connect the first functional element directly or even rigidly to the adjustment device. Preferably, however, when the first functional element is fastened or supported by at least one, advantageously directly by exactly one, joint in an articulated way on the adjustment device. In principle, it is possible to fasten the first functional element in the form of a captive connection to the adjustment device. It could also be sufficient, however, if the first functional element is supported on the adjustment device. In this case, forces acting on the first functional element in the corresponding direction could be introduced into the adjustment device. In the case of support, however, it does not involve a captive connection.

Preferably it is provided that the first functional element is connected to the first and/or second component of the carcass attachment part via or by the adjustment device. The first functional element is thus not connected to the adjustment device by the intermediate connection of other or arbitrarily many other components of the furniture hinge, but instead the forces occurring on the first functional element are advantageously introduced directly via the adjustment device into the first and/or second component of the carcass attachment part.

The adjustment device advantageously involves an adjustment screw that is screwed by a corresponding external thread into an internal thread on the first or second component of the carcass attachment part. The adjustment device in which the first functional element is fastened or supported, however, could also involve known eccentrics or worms, advantageously with a spiral-shaped guide track. The first functional element is also fastened to or supported on this track, e.g., by an extension that is advantageously arranged centrally accordingly. In cases in which the adjustment device changes its position during the adjustment, that is, e.g., in the case of an adjustment screw that is screwed to different depths into at least one of the two components of the carcass attachment part, the already mentioned articulated connection between the functional element and the adjustment device presents itself.

The functional unit advantageously initially involves first a damper that damps the closing and/or opening movement during the pivoting of the door-leaf attachment part relative to the carcass attachment part and thus provides for a soft closing and/or opening especially in the vicinity of the end positions. In this sense, it can be provided that the functional unit is a damper with a piston rod guided in a cylinder with a linear motion and the piston rod and the cylinder can be displaced relative to each other in a linear motion and the first functional element is the piston rod or the cylinder.

In principle, it is also possible, however, to use the type of attachment according to the invention for functional units, such as closing springs or electric motors for opening and/or for closing. For example, the first functional unit could then be a leg or tappet of a closing spring or a housing of a motor or a shaft or rod moving relative to the housing of the motor. Here it is possible that the functional units attached according to the invention support or block, that is, additionally accelerate or delay, an opening or closing movement guided, e.g., by hand. It is also conceivable, however, especially for functional units in the form of motors, that these perform the opening or closing movement, that is, the pivoting movement between the door-leaf attachment part and carcass attachment part at least across a partial region of the path or else also for the entire pivot angle completely by themselves. In an especially preferred way, it is provided that the second functional element, that is, the functional element not fastened to or supported on the adjustment device, is hinged directly or by an intermediate arm and optionally additional intermediate levers and/or additional intermediate arms on an articulated lever of the furniture hinge connecting the door-leaf attachment part to the carcass attachment part so that it can pivot. Other forms of the pressure application of the second functional element, however, are also conceivable, e.g., a slide according to WO 2008/011955 charged by the door-leaf attachment part could be provided for this purpose.

Through the double use according to the invention in the adjustment device, additional components that are used for supporting or fastening the first functional element can be eliminated. The space gained in this way can be used, in particular, such that the functional unit can be arranged at least partially, advantageously completely, in an inner hollow space of the carcass attachment part. In this way it is prevented that the user accidentally becomes caught on a functional unit attached on the furniture hinge on the outside. In addition, the optical impression of the furniture hinge is improved. The door-leaf attachment part can involve a hinge pot. The carcass attachment part can be constructed, e.g., as a longitudinally extended hinge space.

### BRIEF DESCRIPTION OF THE DRAWINGS

Additional features and details of the invention are taken from the description of a preferred embodiment.

Shown are:

FIGS. 1 to 16 are different diagrams of an embodiment according to the invention, and

FIG. 17 is a section through the damper used in the illustrated embodiment.

### DETAILED DESCRIPTION OF THE PREFERRED EMBODIMENT

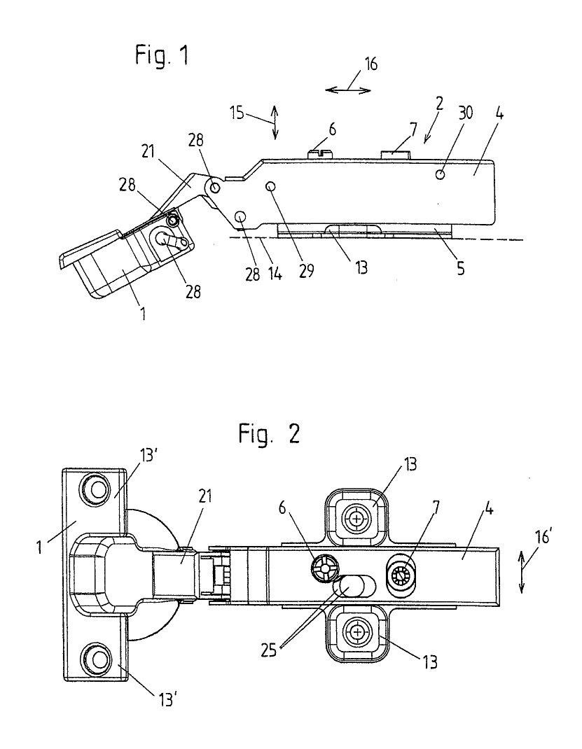

FIG. 1 shows a side view from the outside onto the furniture hinge according to the invention.

FIG. 2 shows a corresponding top view. In these two figures, the furniture hinge is located in the completely opened position.

The door-leaf attachment part 1 of this embodiment is constructed as a hinge pot and the carcass attachment part 2 as a hinge arm. This is a typical, but not absolutely necessary construction of a furniture hinge. As is known, the door-leaf attachment part 1 is connected to the carcass attachment part 2 so that it can pivot via an outer articulated lever 21 and, in this example, through the use of several inner articulated levers 20 and 20′ arranged in parallel and not shown in FIGS. 1 and 2. It involves a so-called four-point hinge in which four articulated axles 28 attach the articulated levers 20, 20′ and 21 to the door-leaf attachment part 1 and to the carcass attachment part 2. The carcass attachment part 2 has the two components 4 and 5. A first adjustment device is constructed in the form of the adjustment screw 6. This is used for contact adjustment, that is, for the adjustment of the spacing between the first component 4 and the second component 5 in one of the directions indicated with the double arrow 15 normal to the usually flat fastening face 14 that is predetermined by the brackets 13 of the second component 5 and is used for contact on the furniture carcass 37. For the so-called depth adjustment, in this embodiment, an eccentric 7 is provided as the adjustment device. This is supported in the first component 4 so that it can rotate and engages with its eccentric pin in a corresponding hole in the second component 5, so that a rotation of the eccentric 7 causes a displacement of the first component 4 relative to the second component 5 in one of the directions 16 and thus causes a depth adjustment. This is known and does not need to be explained further. In order to allow, on one hand, the depth adjustment, but also, on the other hand, the contact adjustment between the two components 4 and 5 connected to each other, a guide axle 30 is provided that is supported in a guide-axle elongated hole 31 so that it can be displaced in the directions 16 parallel to the fastening face 14 in the second component 5, as is to be seen, in particular, in the following sections. This allows the guide axle 30 to pivot the two components 4 and 5 for the contact adjustment and thus an adjustment of the spacing in one of the directions 15 by the adjustment screw 6, but also permits a displacement of the two components parallel to the fastening face 14 in one of the directions 16 by the eccentric 7.

In the illustrated embodiment, the door-leaf attachment part 1 is hinged on the first component 4 of the carcass attachment part 2 so that it can pivot. On the second component 5 of the carcass attachment part, the brackets 13 are fastened integrally for fastening to the furniture carcass 37. The brackets 13 make possible the advantageously flat fastening face 14 provided for contact on the furniture carcass 37. Deviating from the illustrated embodiment, it is naturally also possible, as is known, to construct the brackets 13 for the carcass attachment part 2 in the form of a bracket that can be removed from the second component 5. The fastening of the second component 5 can then be performed in a known way on this bracket, e.g., by a clip or snap-on mechanism. For the sake of completeness, also refer to the brackets 13′ of the door-leaf attachment part 1. These are constructed in a known manner. Naturally, all other fastening methods known in the prior art could also be used for the door-leaf attachment part 1.

The additional holes 25 shown in FIG. 2 in the first component 4 and second component 5 indicate that, in addition to the two adjustment devices 6 and 7, another third, known adjustment device could be provided for height adjustment in one of the directions 16′ when the brackets 13 are constructed as separate base plates and the second component 5 is supported on this so that it can be displaced accordingly. As an adjustment device for this purpose, e.g., in a known way, a worm screw with a spiral-shaped guide track could be provided.

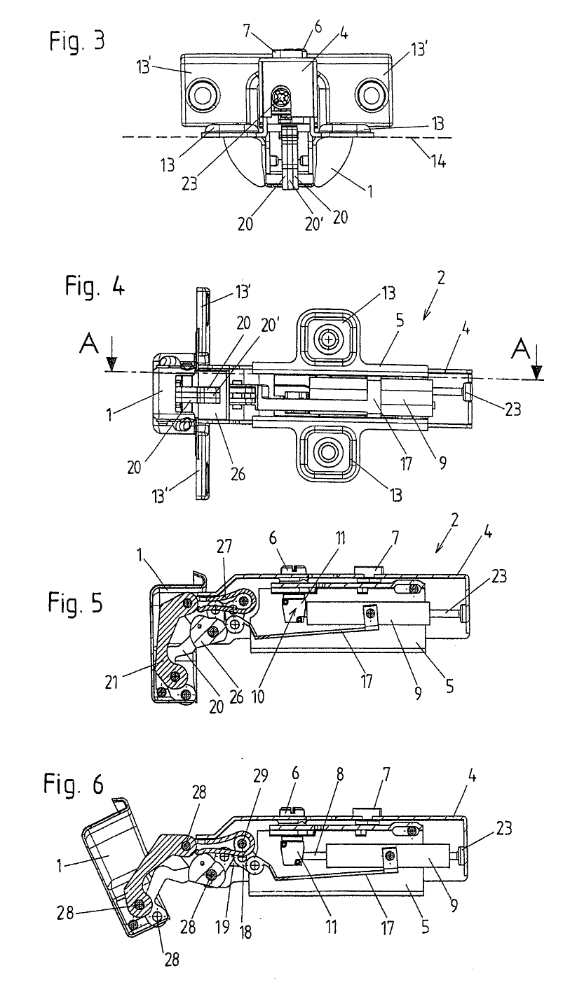

FIG. 3 shows a view from behind of this embodiment of a furniture hinge, wherein the hinge is located in the closed position. The adjustment screw 23 of the damper, that is provided here as functional unit 3 and will be discussed in more detail at the end of the description, is accessible from behind.

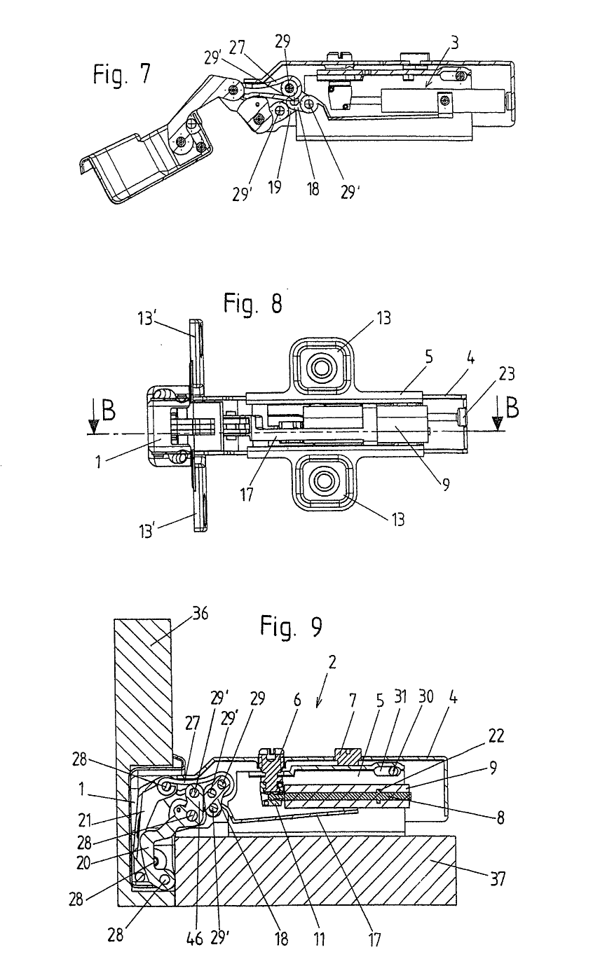

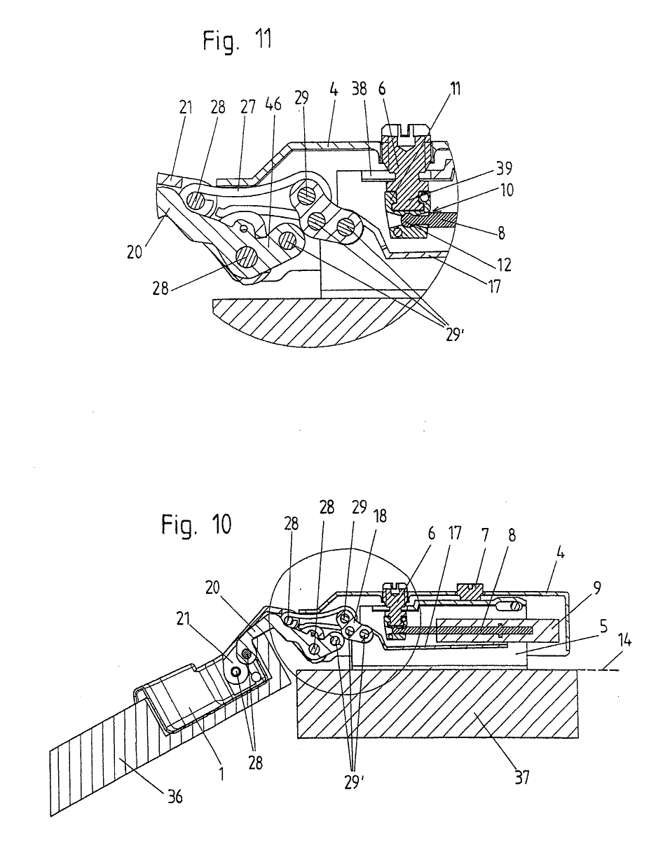

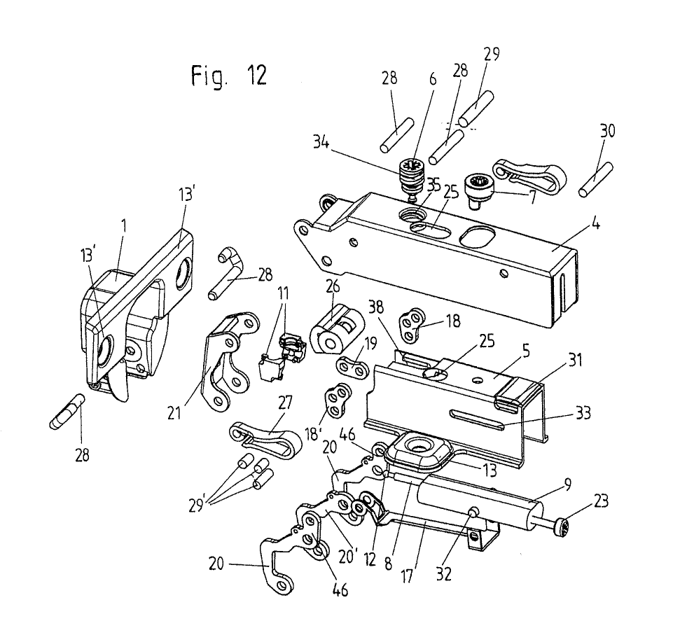

FIG. 4 shows a view from below of this furniture hinge and the section line AA. FIGS. 5 to 7 show sections along this section line AA, wherein the door-leaf attachment part 1 is located in the closed position in FIG. 5, in an intermediate position in FIG. 6, and in the completely opened position in FIG. 7. FIGS. 9 to 11 show sections parallel to section line AA along the section line BB. This is shown from below in the view according to FIG. 8. FIG. 9 shows here again the closed position; the completely opened position is shown in FIG. 10. FIG. 11 shows the area circled in FIG. 10 at an enlarged scale. FIG. 12 shows an exploded-view diagram of the hinge according to the invention.

Before the function of the individual elements of the furniture hinge shown in these diagrams is discussed, it should be noted that not all of the reference symbols are shown in all of the figures, in order to preserve the clarity of the diagram. The functional description following now is based on the synopsis of FIGS. 4 to 12.

The adjustment device 6 constructed as an adjustment screw has an external thread 34 that engages in an internal thread 35 of the first component 4. Here, the adjustment screw 6 can be screwed into and out of the first component 4. In the second component 5, the adjustment screw 6 is guided into an elongated hole 38 that allows a displacement of the adjustment screw 6 in the directions 16 for the depth adjustment relative to the second component 5. For the engagement in the elongated hole 38, the adjustment screw 6 has a corresponding annular groove with which it is guided in the elongated hole 38. By rotating the adjustment screw 6, as already mentioned, a contact adjustment is realized in that the spacing between the first component 4 and the second component 5 is increased or decreased in one of the directions 15 in the region of the adjustment screw 6. Here, the two mentioned components are pivoted relative to each other about the guide axle 30.

According to the invention, the piston rod constructed here as a first functional element 8 in the functional unit 3 constructed as a damper is now fastened to this adjustment screw 6 for contact adjustment. This fastening is not rigid in the illustrated embodiment, but is realized instead by the joint 10. This has a spherical-head receptacle 11 that is constructed in this embodiment in the form of two half shells and in which a spherical head 12 is supported so that it can move or rotate and/or pivot. In the shown embodiment, the spherical-head receptacle 11 is fastened to the adjustment screw 6 and the spherical head is advantageously fastened integrally to the first functional element 8 of the damper. In order for the spherical-head receptacle 11 to not to have to rotate with the adjustment screw 6 about its longitudinal axis, it is favorably provided that the spherical-head receptacle 11 is supported on the adjustment screw 6 so that it can rotate. For the rotating support of the spherical-head receptacle 11, in this embodiment, the T-shaped projection 39 that can be seen especially well in FIG. 11 is provided on the adjustment screw 6 in which the spherical-head receptacle 11 constructed here in the form of two half shells that can be screwed with each other can engage. This form of attachment is naturally also only one example. In general, in any case, it is favorable when the joint 10 or the spherical-head receptacle 11 is supported on the adjustment device so that it can rotate, advantageously about the longitudinal axis, for adjustment devices that can rotate advantageously about their longitudinal axes.

The arrangement shown in the figures could also be constructed differently. It is also possible to provide the spherical-head receptacle 11 directly on the first functional element 8, that is, here on the piston rod and the spherical head 12 on the adjustment screw 6 accordingly. In addition, it does not necessarily involve a spherical joint; other joints are also conceivable. In addition, the direct connection of the mentioned components to each other is favorable but not absolutely necessary. Through the joint 11, in any case, slight pivoting movements provided by the lever mechanism still to be explained on the functional unit or on the damper could be allowed.

As the second functional element 9 of the damper or the functional unit 3, the cylinder 9 is constructed here. This is supported on the piston rod 8 so that it can be displaced relative to the adjustment device 6. The intermediate arm 17 is hinged on the cylinder 9 so that it can pivot about the guide pin 32, wherein this arm is hinged on the articulated lever projections 46 of the articulated lever 20 of the furniture hinge so that it can pivot in the shown embodiment, in turn, by the additional intermediate lever 18, 18′ and the additional intermediate arm 19. The articulated lever projection or projections 46 extend the articulated lever or levers past the articulated axle 28 and are used for holding an intermediate lever axle 29′. In the illustrated embodiment, it involves the inner articulated levers that connect the door-leaf attachment part 1 to the carcass attachment part 2 so that they can pivot. The intermediate arm 17 hinged on the cylinder 9 so that it can pivot is hinged on the two additional intermediate levers 18 and 18′ by an intermediate lever axle 29′ so that it can pivot. These can pivot by the intermediate lever axles 29 supported in the first component 4 of the carcass attachment part 2. The third intermediate lever axle 29′ engaging on the additional intermediate levers 18 and 18′ connects the additional intermediate levers 18 and 18′ in an articulated way to the additional intermediate arm 19 that is fastened to the articulated lever projections 46 and thus on the inner articulated levers 20 by another intermediate lever axle 29′ so that it can pivot or rotate. That the inner articulated lever and the articulated lever projections have a multi-part construction is naturally only one example. The same could also be realized, e.g., with an integrally constructed, inner articulated lever and an integrally formed articulated lever projection or also with a corresponding attachment, e.g., likewise by a projection on the outer articulated lever 21.

Through the lever mechanism constructed in this way, a movement of the articulated lever 20 during the opening or closing of the hinge is converted into a displacement of the cylinder 9 on the piston rod 8, wherein the functional unit constructed here as a damper is activated and damps the closing and/or opening process of the hinge accordingly. In what angular positions and how strongly the damping effect acts depends on the translation of the lever mechanism and on the properties of the damper. Numerous different constructions that could also be used in hinges according to the invention exist for this purpose in the prior art. For the sake of completeness it should be noted that for moving the cylinder 9, the lever mechanism shown here in the embodiment is not absolutely necessary. It is as well just as possible to revert to solutions already known from the prior art for transferring the movement of an articulated lever or the door-leaf attachment part to a damper. Here reference is made explicitly to the prior art mentioned above.

The closing spring 27 arranged here between one of the articulated axles 28 and the intermediate lever axle 29 and activated by the connecting rod 26 locked in rotation with the inner lever 20, 20′ is also known and does not have to be explained here further.

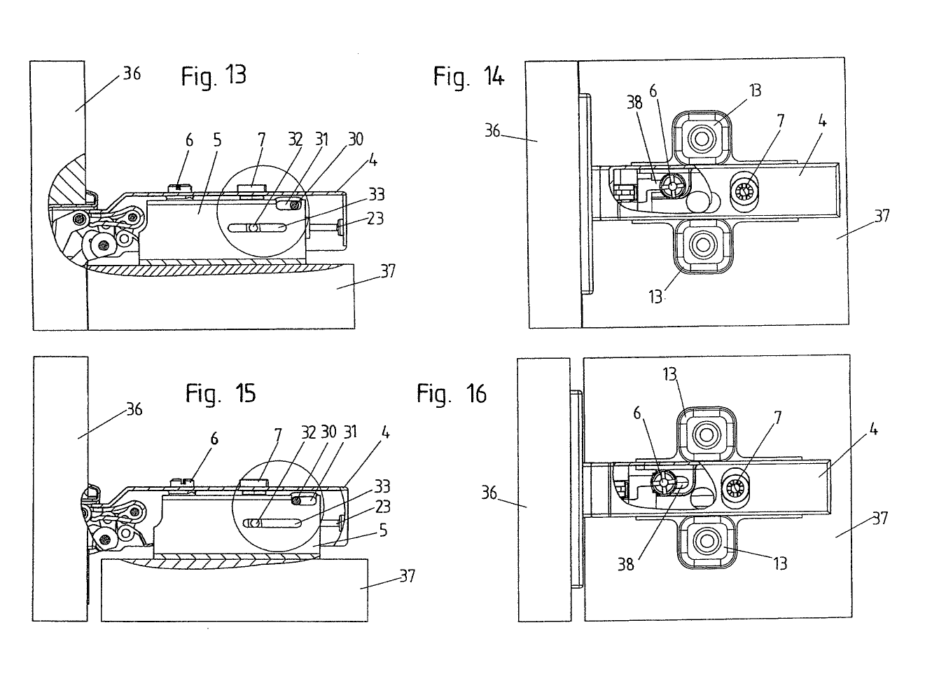

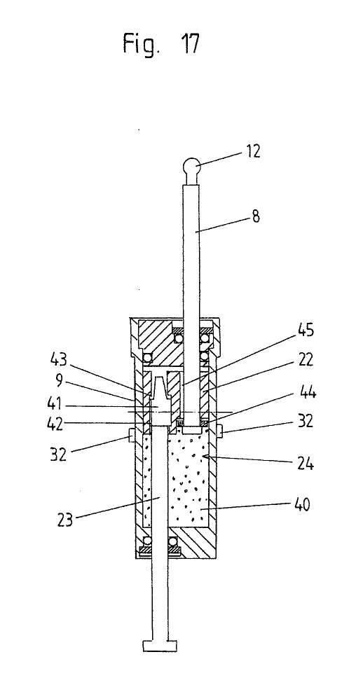

In FIGS. 13 to 16, the already discussed embodiment of a hinge according to the invention is illustrated again in the closed position, wherein, in FIGS. 13 and 14, the distance between the door leaf 36 and the furniture carcass 37 is set to a minimum using the eccentric and to a maximum in FIGS. 15 and 16. In FIGS. 13 and 15, a longitudinal section is shown again. Especially easy to see is the guide of the guide pin 32 of the cylinder 9 of the damper in the guide-axle elongated hole 33 of the second component 5 and the already mentioned guide of the guide axle 30 in the guide-axle elongated hole 31.

The partially broken diagram of FIGS. 14 and 16 shows how the adjustment screw 6 is displaced in the elongated hole 38 by the eccentric 7 for the depth adjustment.

FIG. 17 now shows another longitudinal section through the damper used in the first embodiment. The piston rod 8 and the adjustment screw 23 are fastened to the piston 22 of the damper. For the damping movement, the cylinder 9 is displaced by the guide pin 32 relative to the piston rod 8 and the adjustment screw 23. The adjustment screw 23 and the piston rod 8 are sealed, as is known, by seals that do not have to be explained further. The piston 22 divides the inner hollow space 24 of the cylinder 9 into two working spaces that are filled with the damping medium 40, e.g., a suitable oil. FIG. 17 shows the position before the beginning of the damping stroke. During the damping stroke itself, the damping medium 40 must flow through the first flow channel 42 from the lower working space into the upper working space through the piston 22, which leads to the desired damping effect through the narrowed flow cross section in the piston 22. The first flow channel 42 is constructed in the region of the pin 41 of the adjustment screw 23 as a channel-shaped longitudinal groove in the pin. For the transition to the conical projection of the pin 41, the damping medium 40 must pass the annular space 43, in order to flow past the conical projection into the upper work space. The pin 41 carries an external thread that is screwed into the piston. By turning the adjustment screw 23, the annular space 43 is increased or decreased, which changes the flow cross section with which the damping properties can be adjusted. A second flow channel 45 is provided in the piston 22 parallel to the piston rod 8. This is closed during the damping stroke by the check disk 44 and is used only to increase the flow cross section through the piston during the return stroke in the position shown in FIG. 17. For the sake of completeness, it should be noted that the damper shown here is naturally only one example. Any other damper known in the prior art could also be connected according to the invention to an adjustment device of a furniture hinge.

Finally, it should also be noted that the adjustment device on which the first functional element 8 of the functional unit 3 is fastened or supported does not absolutely have to be an adjustment screw for contact adjustment. It is also possible, e.g., to use an adjustment device 7 for depth adjustment for fastening or supporting a functional element. Thus, it would be possible for an alternative construction, based on the illustrated variant, e.g., to fasten the cylinder 9 as a first functional element to a projection attached advantageously centrally on the eccentric 7 or in some other way on the eccentric 7. This fastening could be articulated or also rigid. The piston rod 8 would then be the second functional element that could then be charged by means of corresponding lever mechanisms or the like by one of the articulated levers or the door-leaf attachment part. This attachment could then be realized, e.g., as shown in WO 2008/011955, by a slide charged by the door-leaf attachment part or, as shown in WO 2008/009345 in the first embodiment, by a corresponding attachment to one of the articulated levers. Alternatively, numerous other constructions of the invention are also naturally possible here. For example, it is also conceivable to replace the damper used in the illustrated embodiment by an electric motor, advantageously, a linear motor. The attachment of the housing of the electric motor could then be realized similar to the attachment of the cylinder 9. A rod of the electric motor that could be displaced longitudinally accordingly could then be linked in an analogous way as in the shown embodiment to the adjustment screw 6. Accordingly, it would also be possible to replace the damper by a spring mechanism, in order to attach another form of the functional unit.

### LEGEND TO THE REFERENCE SYMBOLS

1 Door-leaf attachment part
2 Carcass attachment part
3 Functional unit
4 First component
5 Second component
6 Adjustment device
7 Eccentric
8 First functional element
9 Second functional element
10 Joint
11 Spherical-head receptacle
12 Spherical head
13,13′ Bracket
14 Fastening face
15 Direction
16,16′ Direction
17 Intermediate arm
18,18′ Additional intermediate lever
19 Additional intermediate arm
20,20′ Inner articulated lever
21 Outer articulated lever
22 Piston
23 Adjustment screw
24 Inner hollow space
25 Additional holes
26 Connecting rod
27 Closing spring
28 Articulated axles
29,29′ Intermediate lever axles
30 Guide axle
31 Guide-axle elongated hole
32 Guide pin
33 Guide-axle elongated hole
34 External thread
35 Internal thread
36 Door leaf
37 Furniture carcass
38 Elongated hole
39 T-shaped projection
40 Damping medium
41 Pin
42 First flow channel
43 Annular space
44 Check disk
45 Second flow channel
46 Articulated-lever extension

1. A furniture hinge comprising a door-leaf attachment part (1) for fastening to a door leaf (36) and a carcass attachment part (2) connected thereto so that it can pivot for fastening of a furniture carcass (37), and at least one functional unit (3) for influencing a pivoting movement between the door-leaf attachment part (1) and the carcass attachment part (2), the carcass attachment part (2) has a first component (4) and at least one second component (5) and the first component (4) is supported on the second component (5) at least by at least one adjustment device (6) and a relative position of the first component (4) to the second component (5) can be adjusted with the adjustment device (6), the functional unit (3) has a first functional element (8) and at least one second functional element (9), wherein the first functional element (8) is supported so that it can move relative to the second functional element (9), and the first functional element (8) is fastened to or supported on the adjustment device (6).

2. The furniture hinge according to claim 1, wherein the first functional element (8) is connected to at least one of the first or second component (4, 5) of the carcass attachment part (2) via the adjustment device (6).

3. The furniture hinge according to claim 1, wherein forces appearing on the first functional element (8) can be introduced via the adjustment device (6) into the first or second component (4, 5) of the carcass attachment part (2).

4. The furniture hinge according to claim 1, wherein the first functional element (8) is fastened to or supported in an articulated manner on the adjustment device (6) by at least one joint (10).

5. The furniture hinge according to claim 4, wherein the joint (10) has a spherical-head receptacle (11), and a spherical head (12) is supported in the receptacle so that it can move.

6. The furniture hinge according to claim 1, wherein the first functional element (8) is fastened to or supported in an articulated manner on the adjustment device (6) directly by exactly one joint (10).

7. The furniture hinge according to claim 6, wherein the joint (10) has a spherical-head receptacle (11), and a spherical head (12) supported in this receptacle so that it can move.

8. The furniture hinge according to claim 7, wherein the spherical-head receptacle (11) is fastened to the adjustment device (6) and the spherical head (12) is fastened directly to the first functional element (8) or the spherical-head receptacle (11) is fastened directly to the first functional element (8) and the spherical head (12) is fastened directly to the adjustment device (6).

9. The furniture hinge according to claim 8, wherein the spherical-head receptacle (11) is fastened to the adjustment device (6) so that it can rotate.

10. The furniture hinge according to claim 8, wherein the spherical-head receptacle (11) is fastened directly to the adjustment device (6).

11. The furniture hinge according to claim 1, wherein the door-leaf attachment part (1) is hinged on the first component (4) of the carcass attachment part (2) so that it can pivot and the second component (5) of the carcass attachment part (2) is fastened directly or under intermediate connection of additional components to at least one bracket (13) for fastening to the furniture carcass (37), and the bracket (13) allows or has a fastening face (14) for contact on the furniture carcass (37).

12. The furniture hinge according to claim 11, wherein the fastening face (14) is flat.

13. The furniture hinge according to claim 11, wherein with the adjustment device (6), a distance between the first component (4) and the second component (5) can be adjusted in at least one direction (15) normal to the fastening face (14) or in a direction (16, 16′) parallel to the fastening face (14).

14. The furniture hinge according to claim 1, wherein the second functional element (9) is hinged directly or by an intermediate arm (17) and optionally at least one additional intermediate lever (18, 18′) or additional intermediate arm (19) on an articulated lever (20, 20′) of the furniture hinge connecting the door-leaf attachment part (1) to the carcass attachment part (2) so that it can pivot.

15. The furniture hinge according to claim 14, wherein the additional intermediate lever or one of the additional intermediate levers (18, 18′) is hinged on the first component (4) so that it can pivot or on the second component (5) so that it can pivot.

16. The furniture hinge according to claim 1, wherein the functional unit (3) is a damper with a piston rod guided in a linear path in a cylinder and the piston rod and the cylinder can be displaced in a linear path relative to each other and the first functional element (8) is the piston rod or the cylinder.

17. The furniture hinge according to claim 16, wherein the first functional element (8) is the piston rod and the cylinder is supported as the second functional element (9) on the piston rod (6) so that it can be displaced relative to the adjustment device.

18. The furniture hinge according to claim 16, wherein an intermediate arm (17) is hinged so that it can pivot on the cylinder and the intermediate arm (17) is hinged on an articulated lever (20, 20′) of the furniture hinge connecting the door-leaf attachment part (1) to the carcass attachment part (2) so that it can pivot directly or by one or more additional intermediate levers (18, 18′) or additional intermediate arms (19).

19. The furniture hinge according to claim 18, wherein a piston (22) is fixed on the piston rod and an adjustment screw (23) for changing a damping resistance is arranged on the piston (22) on a side opposite the piston rod.

20. The furniture hinge according to claim 1, wherein the functional unit (3) is arranged at least partially in an internal hollow space (24) of the carcass attachment part (2).

21. The furniture hinge according to claim 1, wherein the functional unit (3) is arranged completely in an inner hollow space (24) of the carcass attachment part (2).

22. The furniture hinge according to claim 1, wherein the door-leaf attachment part (1) is a hinge pot.

23. The furniture hinge according to claim 1, wherein the carcass attachment part (2) is a longitudinally extended hinge arm.

24. The furniture hinge according to claim 1, wherein the functional unit (3) is an electric motor.

25. The furniture hinge according to claim 1, wherein the functional unit (3) is a damper.

26. The furniture hinge according to claim 1, wherein the adjustment device (6) is an adjustment screw.
